(19) United States
(12) Patent Application Publication
(10) Pub. No.: US 2010/0313848 A1
(43) Pub. Date: Dec. 16, 2010

(54) THROTTLE BODY AND A METHOD TO MODIFY A THROTTLE BODY

(76) Inventor: Ronald E. Hatton, Mesa, AZ (US)

Correspondence Address: VENABLE, CAMPILLO, LOGAN & MEANEY, P.C., 1938 E. OSBORN RD, PHOENIX, AZ, 85016-7234, US

(21) Appl. No.: 12/817,158

(22) Filed: Jun. 16, 2010

Related U.S. Application Data
(60) Provisional application No. 61/245,252, filed on Sep. 23, 2009.
(60) Provisional application No. 61/187,639, filed on Jun. 16, 2009.

(51) Int. Cl. F02D 9/08

(52) U.S. Cl. 123/337

(57) ABSTRACT

A method and device using at least one groove created in the throttle body wall is described. It is believed that the this throttle body modification that can increase gas mileage, increase horsepower, increase torque, reduce emissions and/or reduce the carbon foot print of a machine such as an internal combustion engine.

This application claims the benefit of Provisional Patent Application Ser. Nos. 61/187,639 filed Jun. 16, 2009 and 61/245,252 filed Sep. 23, 2009, both of which are incorporated by reference herein in their entirety.

### FIELD OF THE INVENTION

This invention generally relates to throttle bodies of machines, mixing valves and engines and a method of modifying throttle bodies. More specifically this invention relates to incorporation of at least one groove located inside a fluid passageway of the throttle body that improves fluid turbulence in a machine such an internal combustion engine. For example, in an internal combustion engine the performance is enhanced such as increased gas mileage, lower fuel emissions, carbon foot print and/or increased horse power and torque.

### BACKGROUND

Many machines, such as internal combustion engines, require precise fluid mixtures, such as air and gasoline, in order to properly run. In this instance, throttle bodies are designed to control fluid flow, such as airflow and/or air-fuel mixtures flow, to the cylinders of an engine. In order to control the fluid flow that reaches the cylinders, the throttle body includes at least one throttle plate attached to a central axis or; for example, a central axis shaft (also known as a throttle shaft) such that the throttle plate is located within a fluid passageway (sometimes known as a throttle bore or duct), or proximal to an end of the fluid passageway. With rotation of the central axis, the throttle plate is able to selectively obstruct flow through the fluid passageway. More specifically, the throttle plate is able to rotate with respect to the fluid passageway in order to adjust the cross-sectional area of the fluid passageway that is not obstructed by the plates (the “effective area”), thus controlling the amount of fluid, such as airflow, that is permitted to flow through the fluid passageway.

In order to control the effective area, the throttle plate is sized and shaped to approximate the cross-sectional area of the fluid passageway so as to substantially or completely obstruct the fluid passageway when the throttle plate is perpendicular to the airflow (the “closed position”). Typically, the throttle plate has a minimal thickness in order to substantially not obstruct the fluid passageway when the throttle plate is angled such that a throttle plate is not substantially perpendicular to the airflow (the “open position”).

When the engine is idling, the throttle plate is therefore in the closed position since only a little air is needed to mix with the small amount of fuel being injected into the engine. On the other hand, if the engine is operating at a speed higher than idle, then more air is needed to mix with the increased amount of fuel being provided to the engine. At speeds higher than idle, the throttle plate is therefore in an open position of a varying angle with respect to the airflow, the angle varying with the engine's air requirements.

In order to completely or substantially obstruct the fluid passageway when the throttle plate is the closed position, it is desirable for the throttle plate to be precisely sized and accurately located within the fluid passageway.

Throttle body spacing blocks are well known in the prior art and are frequently found in the automotive part after-market. Examples include the AFE Silver Bullet Spacer, Airaid Power Aid Spacer, Helix Power Tower Spacer, and Jet Power-Flow Spacers as discussed in the provisional patent applications incorporated by reference herein.

These after-market throttle body spacing blocks typically claim to improve automotive performance. Generally, the throttle body spacing blocks separate the existing throttle body, throttle body injection unit and/or carburetor from the intake manifold of an internal combustion engine found in automobiles. This separation creates increased space that it is posited by the manufactures of the throttle body spacing blocks to increase the air velocity prior to entering the combustion chamber of the engine. Under such a supposition, the increased air velocity would serve to improve the efficiency of the internal fuel combustion. Generally, throttle body spacing blocks are known to consist basically of obvious structural configurations.

In addition, modifications of the internal bore of throttle body spacers are known such as U.S. Pat. No. 6,338,335 issued to Patterson, et on Jan. 15, 2002 and entitled “Throttle body spacing block with continuously grooved aperture(s) for internal combustion engines” which incorporated by reference in its entirety herein. U.S. Pat. No. 6,338,335 teaches the use of a throttle body spacing block having a single, continuous thread pitch groove starting at the inlet opening and stopping at the outlet opening.

One disadvantage of the throttle body spacing blocks is that they require the insertion of an additional element into the air intake system.

Another disadvantage of the throttle body spacing blocks is that they generally do not work with the throttle body plate. It is believed that previous efforts created incomplete, partial, destructive, or no waveforms as applied primarily in the form of throttle body spacing blocks. This invention is believed to overcome these disadvantages by creating a more complete waveform that, it is believed, passes through the intake.

The present invention overcomes these disadvantages by modification of the throttle body itself for any and all internal combustion engines and is not limited to automobiles. While not being limited to any theory, it is believed that the invention also overcome these disadvantages by creating a more complete waveform that, it is believed, passes through the intake. As there is need for an improved throttle body modification that can increase gas mileage, increase horsepower, increase torque, reduce carbon footprint and/or reduce emissions, it is believed that the present invention substantially fulfills these needs.

### SUMMARY

One embodiment of the present invention relates to a throttle body comprising a housing having a throttle body wall including an outside surface and an inside surface wherein the inside surface forms a fluid passageway leading from an open end to a discharge end of the housing; a throttle plate located in the fluid passageway and having a front surface facing the open end of the fluid passageway and back surface on the opposite side wherein the throttle plate is coupled to the housing by a central axis and wherein the throttle plate may be rotated from a closed position to an open position; and at least one groove in the throttle body side wall near to the throttle plate wherein the at least one groove modifies fluid flow though the throttle body in cooperation with the throttle plate movement from the closed position.

Preferably, the at least one groove is located near the front surface of the throttle plate that rotates toward the at least one groove when the throttle plate is moved from the closed position. Also preferably, the at least one groove is located near the back surface of the throttle plate that rotates toward the at least one groove when the throttle plate is moved from the closed position. In another preferable manner, the at least one groove has a depth and a width of one half thickness of the throttle body wall and more preferably the at least one groove forms a curve from the depth to the groove edge furthest from the throttle plate when the throttle plate is in a closed position. In yet another preferable embodiments, the at least one groove is a hemispherical cut or a compound cut.

An additional preferable embodiment includes at least one groove in the throttle body side wall that is perpendicular to direction defined by fluid flow between the open end and the discharge end, more preferably, the at least one groove covers at least one quarter of the inside surface, and most preferably, the at least one groove extends in substantially one-half of the inside surface bounded between the plane formed by a longitudinal axis, of the fluid passageway, and the central axis.

Another embodiment of the invention includes a method of creating a modified throttle body comprising the step of creating at least one groove in an inside surface of a housing having a fluid passageway and a throttle plate located in the fluid passageway and coupled to the housing by a central axis wherein the at least one groove is located near the throttle plate. Likewise, an embodiment of the invention includes a method of creating or enhancing wave pulses in throttle body comprising the step of creating at least one groove in an inside surface of a housing having a fluid passageway and a throttle plate located in the fluid passageway and coupled to the housing by a central axis wherein the at least one groove is located near the throttle plate.

Yet another embodiment of the invention includes a method of reducing the carbon footprint of an engine comprising the step of creating at least one groove in an inside surface of a housing having a fluid passageway and a throttle plate located in the fluid passageway and coupled to the housing by a central axis wherein the at least one groove is located near the throttle plate.

An additional embodiment of the invention includes a method of creating enhanced movement of fluids comprising the step of creating at least one groove in an inside surface of a housing having a fluid passageway and a throttle plate located in the fluid passageway and coupled to the housing by a central axis wherein the at least one groove is located near the throttle plate.

A further embodiment of the invention includes a bit for creating at least one groove in a throttle body comprising a shank to couple to a high speed rotary tool, and a cutting head having a hemispherical portion nearest the shank end terminating in a flat surface or, alternatively, a bit creating at least one groove in a throttle body comprising a shank to couple to a high speed rotary tool, and a cutting head having a hemispherical end furthest from the shank and having an oblique angle from the shank to the equator of the cutting head

### BRIEF DESCRIPTION OF THE DRAWINGS

FIG. 1 shows a standard configuration of a stock throttle body with the linkage omitted for visibility.

FIG. 2 shows an oblique view of throttle plate in throttle body where the throttle plate is on a central axis, specifically a central axis shaft, so that throttle plate rotates to open when an accelerator is depressed.

FIG. 3 shows a side view diagram of a standard configuration of a stock throttle body with a throttle seat and a preferred direction of rotation.

FIG. 4 shows a partial cross-sectional side view diagram of a preferred embodiment of an inferior groove placement in relationship to a throttle plate in a standard configuration of a stock throttle body.

FIG. 5 shows a partial cross-sectional side view diagram of a preferred embodiment of a superior groove placement in relationship to a throttle plate in a standard configuration of a stock throttle body.

FIG. 6 shows a cross-sectional side view diagram of one possible theory of the invention when a preferred embodiment of the at least one groove placement in relationship to throttle plate in a throttle body open at 10% of acceleration.

FIG. 7 shows a cross-sectional side view diagram of one possible theory of the invention of a toroidal shape pressure wave of a preferred embodiment of the at least one groove placement in relationship to throttle plate in a throttle body.

FIG. 8 shows a cross-sectional side view diagram of one possible theory of the invention when a preferred embodiment of the at least one groove placement in relationship to throttle plate in a throttle body open at 85% of acceleration.

FIG. 9 shows an open end view diagram of one possible theory of the fluid movement of preferred embodiment of the invention at lower engine speeds.

FIG. 10 shows an open end view diagram of one possible theory of the fluid movement of preferred embodiment of the invention at higher engine speeds.

FIG. 11 shows a cross-sectional side view diagram of one possible theory of the fluid movement of a wave pattern of low pressure pulses of a preferred embodiment of the invention at higher engine speeds.

FIG. 12 shows a side view diagram of groove cuts in the throttle body wall.

FIGS. 13 a, 13 b and 13 c shows preferred embodiments of one configuration of the bits of the invention.

FIGS. 14 a, 14 b and 14 c shows another preferred embodiments of one configuration of the bits of the invention.

FIGS. 15 a, 15 b and 15 c shows another preferred embodiments of one configuration of the bits of the invention.

### DESCRIPTION

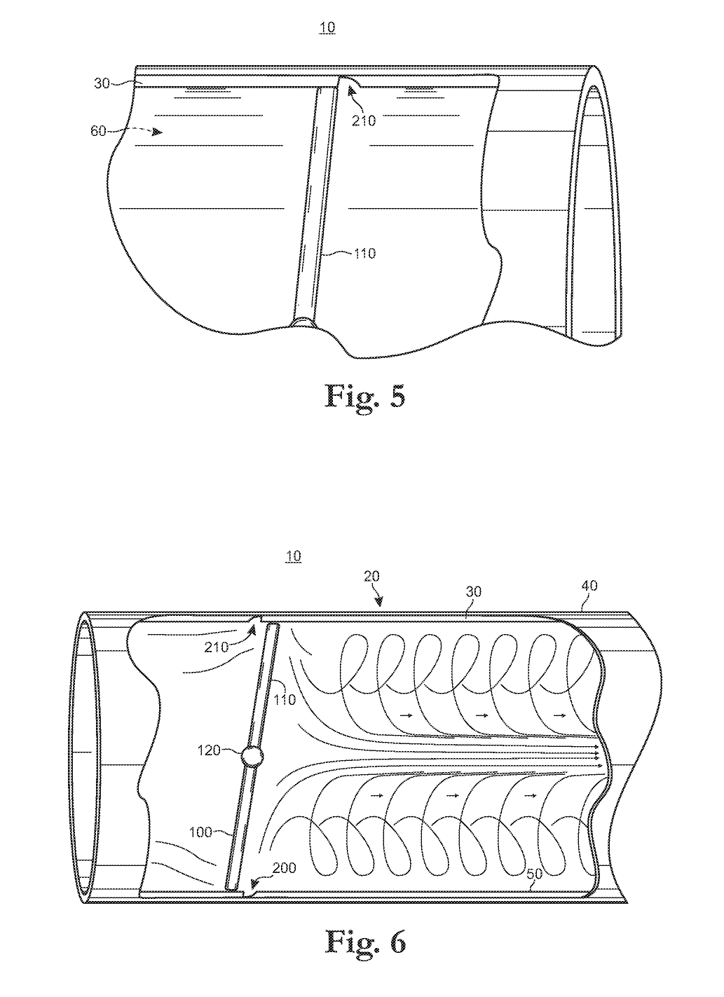

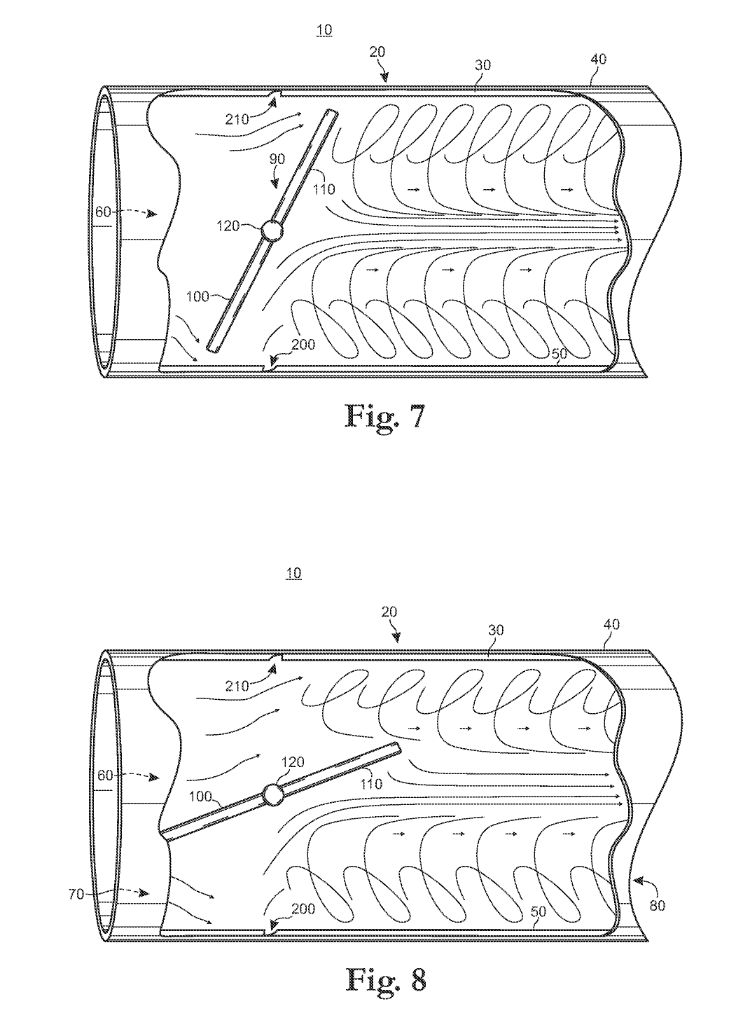

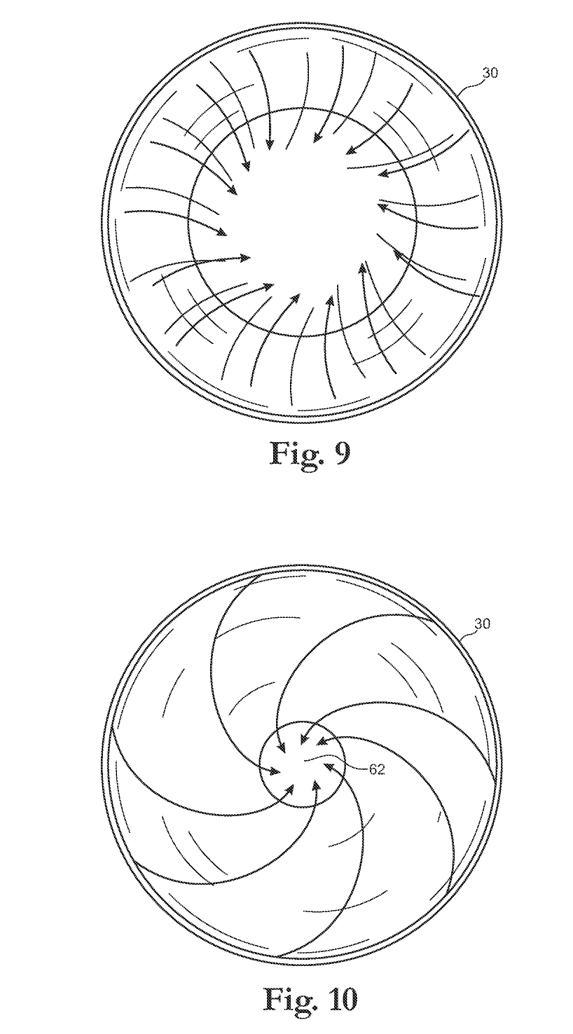

In a preferred embodiment of the invention, the aerodynamic design of throttle bodies are changed (or modified) to, what is believed, create higher vaporization of fuels, reduce emissions and reduce fuel consumption. While not being limited to its proposed theory, it is believed that the invention causes the throttle to be more responsive at lower speed operation. The preferred invention is believed to create a pressure wave at the throttle plate and additional turbulence such that it increases vaporization and blending of liquid in the system to which it is applied possibly like those proposed in FIGS. 6 through 11. For example, it is believed that the invention causes liquids to vaporize (for example, fuels including but not limited to gasoline) enabling its use in the internal combustion engine such as normally aspirated gasoline engines to achieve better explosive properties and mileage (i.e. efficiency) and performance gains including torque at wider ranges than any previous modifications or inventions.

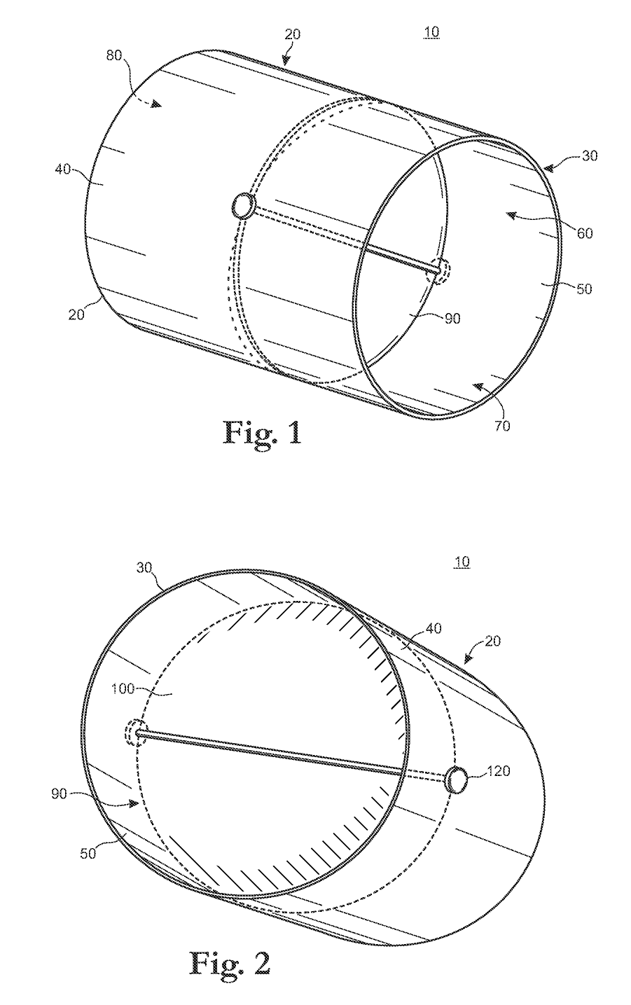

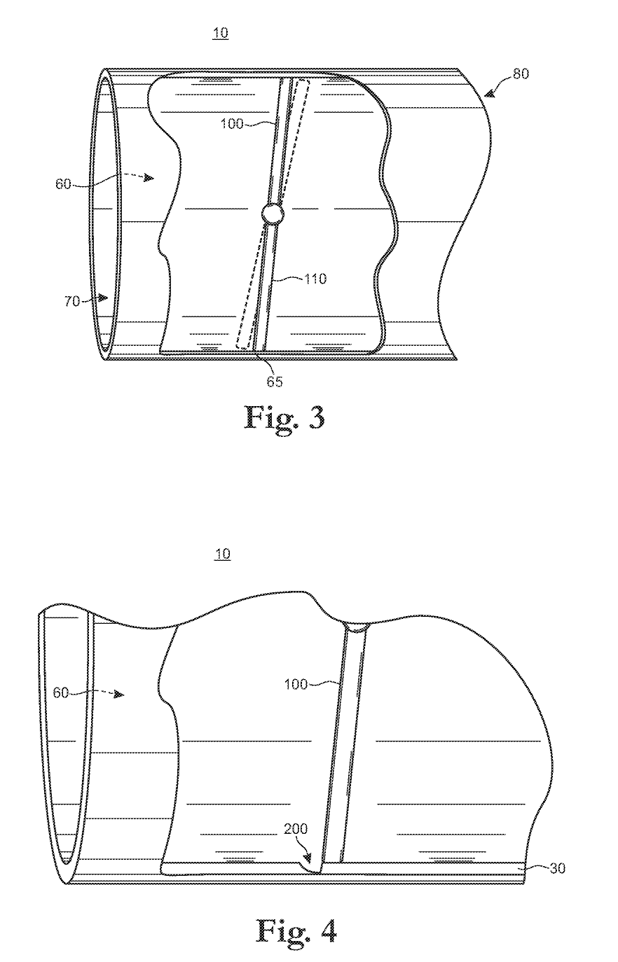

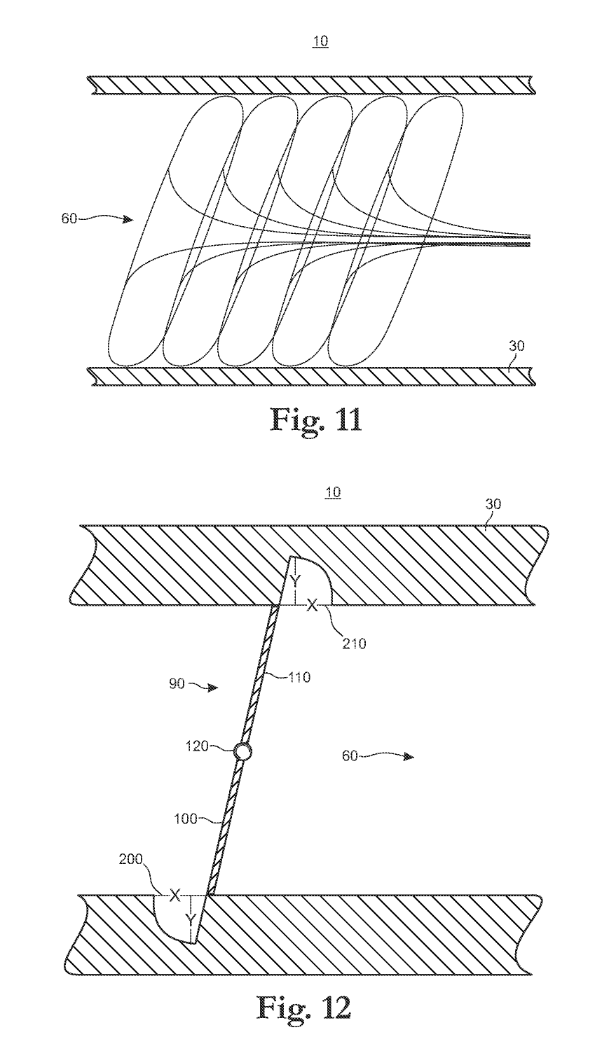

A standard configuration of a stock throttle body 10 (with the linkage omitted for visibility) is shown in FIG. 1. The throttle body 10 includes a housing 20 having a throttle body wall 30. The throttle body wall 30 has an outside surface 40 and inside surface 50 wherein the inside surface 50 defines the fluid passageway 60 and the fluid passage 60 has a longitudinal axis 62 (see FIG. 11). Preferably the housing 20 is cylindrical, but maybe of any geometry that will work with fluid flow. The housing also includes an open end 70 and a discharge end 80 so that the fluid moves from the open end 70 to the discharge end 80. Further, the term fluid includes any liquid or vapor such as air and the term throttle body means any device used for metering fluids. Housings for throttle bodies are well known and are typically made of metal or other suitable materials.

Also as shown in FIGS. 1 and 2, the throttle body 10 also includes a throttle plate 90 located in the fluid passageway 60 and having a front surface 100 facing the open end of the fluid passageway 60 and having a back surface 110 on the opposite side from the front surface 100. Throttle plates are well known and are typically made of thin metal or other suitable materials. As shown in this embodiment, the throttle plate 90 is coupled to the housing a central axis 120. While the central axis may be coupled by any means to the housing such as pins, shaft or other mechanical or magnetic structure, preferably the central axis 120 is a central axis shaft and attaches to the throttle plate 90 and is rotatably (or pivotally) connected to the housing 20. When the throttle plate 90 is in a closed position, it blocks the passage of fluid through the fluid passageway 60. Typically, when the throttle plate 90 is in closed position it forms a fit with a throttle seat 65. The throttle plate 90 also has an open position that varies between 0 degrees and 90 degrees with respect to rotation from the closed position. A throttle plate means any obstruction in the fluid passageway.

In a preferred embodiment of the invention, at least one groove 200 or 210 is created into the throttle body wall 30 as seen in FIGS. 4 though 8 and 12 wherein created means cut, molded, machined, formed, or anything that makes a groove in throttle body wall 30. In one preferred embodiment shown in FIG. 4, the at least one groove 200 has inferior groove placement (at the bottom of the housing 20). In another preferred embodiment shown in FIG. 5, the at least one groove 210 has inferior groove placement (at the top of the housing 20). While the invention can be practiced with one groove, combinations of grooves are also within the scope of the invention. Further, the at least one groove preferably includes at least one quarter of the circumference of the inside surface (i.e. the cylindrical passageway formed by the inside surface 50), but it is possible that such a groove need not be continuous and may be combined with other grooves. More preferably the at least one groove preferably includes at least one half of the circumference of the inside surface (i.e. the cylindrical passageway formed by the inside surface 50), and most preferably, the one half is bounded by a plane formed by a longitunal axis 300 of the fluid passageway and the central axis 120. It is, however, preferred as shown in FIG. 5, to use one groove placed after the throttle plate 90 (that is placed toward the discharge end when the throttle plate is in the closed position) and is superiorly placed if the rotation of the throttle plate 90 is clockwise (if the rotation of the throttle plate is counter clockwise then inferior placement of the one groove would be preferred).

Preferably, the at least one groove 200 or 210 is placed near to the throttle plate and works cooperatively with the throttle plate 90 to modify the fluid flow such as enhancing a pressure wave or toroidal nature of the fluid flow, and, more preferably, the at least one groove 200 or 210 does not interfere with the throttle seat 65. Most preferably, the at least one groove is placed near the position of the throttle plate when the throttle plate is in idle position such as when an engine is idling. In a preferred embodiment, the at least one groove 200 or 210 has a depth (y) and a width (x) that are roughly equivalent as shown in FIG. 12. In another preferred embodiment, the groove has the following characteristics x=y and the radius of curvature (z) (not depicted) is 0.8x. It is believed that the dimensions may be varied for x, y and z as long as the pressure wave is created or enhanced. Further, in a preferred embodiment the dimension of x is 3 millimeters, but the value of x may be varied between 2 mm and 4 mm. In a most preferred embodiment, the dimension x is one-half the thickness of the throttle body wall. Preferably, the groove dimensions are adjusted according to the characteristics of the individual application as based on the variables of displacement and intake air speed.

Preferably, the at least one groove 200 or 210 is perpendicular to the inside surface, more preferably at least one groove 200 or 210 is perpendicular to direction defined by fluid travel from the open end to the discharge end, but most preferably, the at least one groove 200 or 210 is slightly curved to match the throttle body plate consistent with an imaginary slice made through the housing in the plane formed by the throttle plate 90 when it is in an idle position.

In a preferred method, the at least one groove may be created by a hemispherical cut using a bit 300 wherein a bit means any tool for altering or creating shapes in structures. In another preferred embodiment, compound cuts may be created by a special bit or by making one or more additional cuts next to or within a previous groove.

While not being bound by any theory suggested herein, it is believed that the fluid flow is modified by the at least one groove to create pressure waves and possibly rolling toroidal pressure waves and that the pressure waves maintain their integrity of the wave pulse as postulated in FIGS. 6 through 11. It is believe that this mechanism or one like it provides a method to increase gas mileage, increase horsepower, increase torque, reduce emissions and/or reduce the carbon foot print of a machine, especially an internal combustion engine.

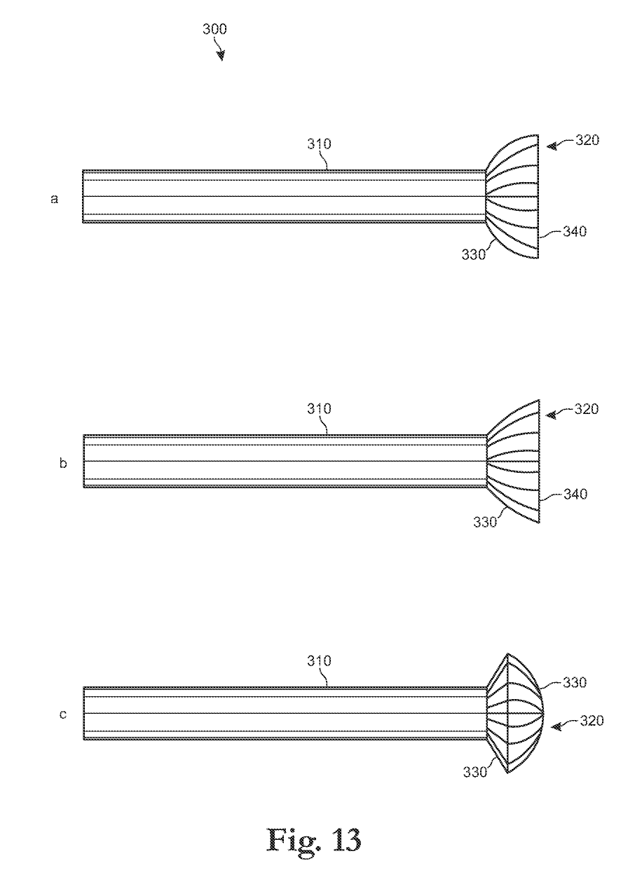

This invention also includes a method of creating the at least one groove in the throttle body side wall 30. In a preferred embodiment the at least one groove 90 may be cut into the throttle body side wall 30 using a bit 300 described in FIGS. 13-15. Preferably the bit 300 is used with a high speed rotary tool to cut a groove into the throttle body wall 30 of an existing throttle body 10 on an engine. In the preferred embodiment, as throttle bodies differ from engine to engine, different bits may be used to create the at least one groove. Preferred embodiments found in FIG. 13-15 include one or more of the following elements: a shank 310, a cutting head 320, a hemisphere section 330, a flat surface 340, a oblique angle portion 350, tapered shank section 360 and/or a reduced shank section 370.

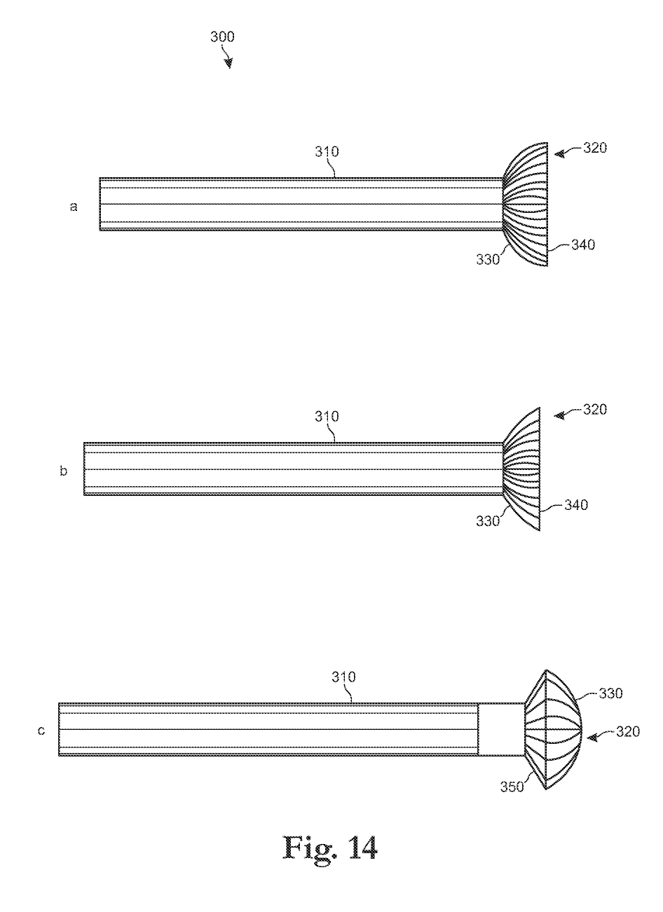

The preferred embodiments shown in FIGS. 13a, 14a, an 15a show bits used for a primary cut having a hemispherical portion terminating in a flat surface which is most preferably a 50 percent cut at the equator of the hemisphere. This bit would be preferably used for the primary cut on the portion in front of the throttle body as seen in FIG. 12 thereby generating the principal shape for the waveform producing groove. Also, preferably this bit may be used for the primary cut on the portion in front of the throttle body as seen in FIG. 12 when access is available to the portion of the throttle body.

The preferred embodiments shown in FIGS. 13b, 14b, and 15b show bits used for a secondary cut having a hemispherical portion terminating in a flat surface which is most preferably a 60 percent cut. This bit may be preferably used for a secondary cut inside the primary groove on the portion in front of the throttle body. It is believed that additional modification of the primary may enhance the wave being generated; however, other modifications or configurations of the groove could also be envisioned to enhance the wave being generated.

The preferred embodiments shown in FIGS. 13c, 14c, and 15c show bits where the cutting material is removed from the shank end of a spherical cutter, and where the non-cutting surface on the shank end is preferably at a 110°-120° oblique angle from shank to the equator, originating at a point on the shank at 50 percent of diameter. For example, FIG. 13c shows a 5/16″ ball—origin at 5/32″ from the end of the cutting surface. This bit would be preferably used for the primary cut on the portion in back of the throttle body as seen in FIG. 12 especially where access to the both sides of the throttle plate is prohibited by other design considerations of stock air systems. The use of this bit in cutting a groove which can generate the principle shape for the waveform producing groove.

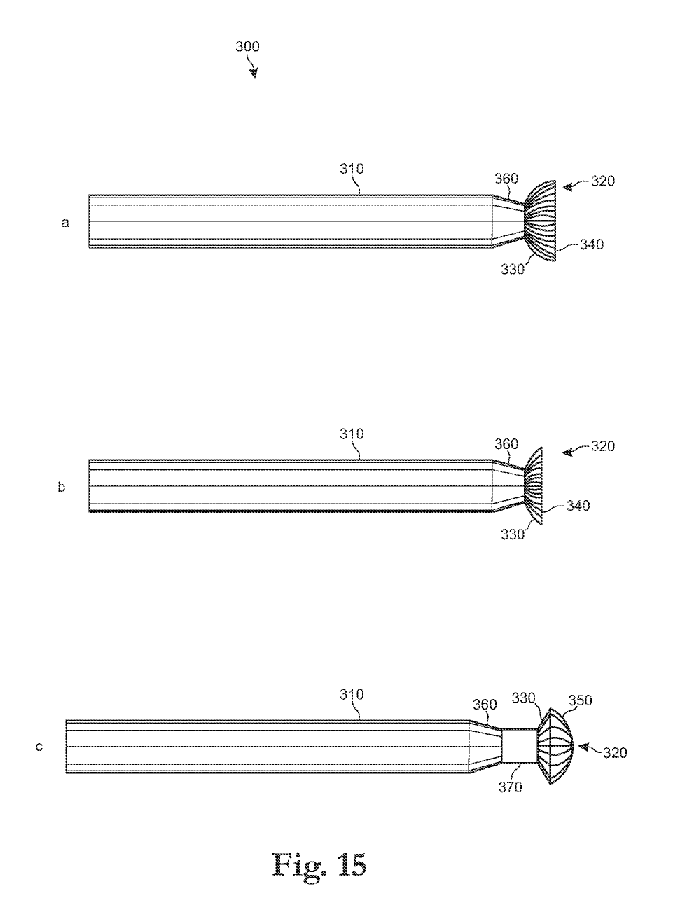

FIG. 15 shows preferred embodiments where material may be removed from shank so that the bit may reach the throttle body.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A throttle body comprising
a housing having a throttle body wall including an outside surface and an inside surface wherein the inside surface forms a fluid passageway leading from an open end to a discharge end of the housing;
a throttle plate located in the fluid passageway and having a front surface facing the open end of the fluid passageway and back surface on the opposite side wherein the throttle plate is coupled to the housing by a central axis and wherein the throttle plate may be rotated from a closed position to an open position; and
at least one groove in the throttle body side wall near to the throttle plate wherein the at least one groove modifies fluid flow though the throttle body in cooperation with the throttle plate movement from the closed position.

2. The throttle body of claim 1 wherein the at least one groove is located near the front surface of the throttle plate that rotates toward the at least one groove when the throttle plate is moved from the closed position.

3. The throttle body of claim 1 wherein the at least one groove is located near the back surface of the throttle plate that rotates toward the at least one groove when the throttle plate is moved from the closed position.

4. The throttle body of claim 1 wherein the groove has a depth and width that is roughly equivalent.

5. The throttle body of claim 4 wherein the at least one groove forms a curve from the depth to the groove edge furthest from the throttle plate when the throttle plate is in a closed position.

6. The throttle body of claim 1 wherein the at least one groove has a depth and a width of one half thickness of the throttle body wall.

7. The throttle body of claim 1 wherein the at least one groove is a hemispherical cut.

8. The throttle body of claim 1 wherein the at least one groove is a compound cut.

9. The throttle body of claim 1 wherein the at least one groove in the throttle body side wall is perpendicular a direction defined by fluid flow between the open end and the discharge end.

10. The throttle body of claim 9 wherein the at least one groove covers at least one quarter of the inside surface.

11. The throttle body of claim 9 wherein the at least one groove covers at least one half of the inside surface.

12. The throttle body of claim 1 wherein the fluid passageway has a longitudinal axis and wherein the at least one groove extends in substantially one-half of the inside surface bounded between the plane formed by the longitudinal axis and the central axis.

13. The throttle body of claim 1 wherein the at least one groove is slightly curved to match an imaginary slice made through the housing in a plane formed by the throttle plate.

14. The throttle body of claim 13 wherein the throttle plate is in an idle position

15. A method of creating a modified throttle body comprising the step of creating at least one groove in an inside surface of a housing having a fluid passageway and a throttle plate located in the fluid passageway and coupled to the housing by a central axis wherein the at least one groove is located near the throttle plate.

16. A method of creating wave pulses in throttle body comprising the step of creating at least one groove in an inside surface of a housing having a fluid passageway and a throttle plate located in the fluid passageway and coupled to the housing by a central axis wherein the at least one groove is located near the throttle plate.
